(19) United States
(12) Patent Application Publication
(10) Pub. No.: US 2006/0082329 A1
(43) Pub. Date: Apr. 20, 2006

(54) Inverter and method for rapid warm-up of luminance loadings

(76) Inventor: Ching-Chung Chang, Taipei (TW)

Correspondence Address: RABIN & BERDO, P.C.;Suite 500, 1101 14 Street, N.W., Washington, DC, 20005, US

(21) Appl. No.: 11/047,645

(22) Filed: Feb. 2, 2005

(30) Foreign Application Priority Data
Oct. 15, 2004 (TW) 93131474

(51) Int. Cl. H05B 39/04

(52) U.S. Cl. 315/291; 315/224

(57) ABSTRACT

An inverter and a method for rapid warm-up of luminance loadings are disclosed, thereby minimizing the warm-up time and maintaining continuity of luminance of luminance loadings. The inverter includes a voltage source, a sensor, a voltage regulator, and a converter. When heating the luminance loadings starts, the inverter detects the temperature of luminance loadings by the sensor and then provides the luminance loadings with a voltage corresponding to the detected temperature. Further, the inverter detects the temperature of luminance loadings by the sensor and automatically adjusts the voltage supplied to the luminance loadings by the voltage regulator according to detected temperature during the warm-up of luminance loadings.

### BACKGROUND

1. Field of Invention

The invention relates to an inverter and the method thereof for luminance loadings, and more particular, to an inverter and a method for rapid warm-up of luminance loadings to the temperature required for stable luminance.

2. Description of the Related Art

The cold cathode fluorescent lamp (CCFL) has a layer of fluorescence coated on the inner wall of a glass tube. Some inert gas and minute mercury are enclosed inside of the lamp. When the electrodes discharge inside the tube, electrons hit and excite the mercury atoms to radiate ultraviolet (UV) light. The UV light then excites the fluorescence on the tube wall to generate visible light of the same color temperature. Since the CCFL has a small tube, a bright surface, and a long lifetime, it is widely used as the backlighting source of liquid crystal displays (LCD), automatic office equipment (e.g. scanners and multiple function machines), and illumination (e.g. indicators and photo catalytic illumination).

However, a fairly high input voltage (about hundreds of volts) is required when the CCFL is starting and working. The high-voltage power is provided by its driver or inverter. Therefore, the quality of power which is outputted by the driver (or inverter) determines the brightness quality and stability of the CCFL.

Generally speaking, the CCFL on an optical scanner needs some time to operate normally after the power is turned on. This is because the brightness of the CCFL continuously increases until its brightness becomes stable. This period is called the warm-up time. If scanning is performed during the warm-up time, the scanned image may have inhomogeneous brightness and bad quality because the brightness is not stable and the brightness continues to increase. This is why many scanners have to wait for about three minutes of warm-up time after their powers are turned on before they can function correctly. The warm-up time takes longer if the machine is running in a cold country or low-temperature environment. The user may think that the machine is out of order and requires maintenance and repair.

Many methods have been proposed to rapidly warm up the CCFL. For example, one can add a metal electrode outside the CCFL. This kind of methods makes use of the heat from the metal electrode coiled around the tube to force the temperature of the tube to rapidly rise. However, an additional step is needed for the extra metal electrode. Secondly, this causes extra cost, including the material cost and the power cost. More importantly, the metal electrode outside the tube may block the light and result in inhomogeneous brightness of the CCFL to affect the scanning quality.

In the U.S. Pat. No. 5,907,742, a control method of using double input voltages is introduced. That is, a higher input voltage (about 12 V) is supplied during the warm-up time to quickly achieve the work temperature. After the warm-up time, a lower input voltage (about 8 V) is supplied to maintain the normal operation. However, to supply two different input voltages, a pulse width modulated (PWM) control circuit is used to control the input voltage. This circuit mode is complicated in its design. Moreover, the inverter used here has a built-in frequency oscillator whose oscillation frequency has an uncertainty between 35 KHz and 45 KHz as temperature and voltage vary. Therefore, the luminance may be unstable, deteriorating the scanning quality.

Another rapid warm-up method uses a photo sensor to detect the actual luminance of the CCFL in order to control the input power supply for quickly achieving the required brightness. Such a method is disclosed, as shown in the U.S. Pat. No. 6,294,883 B1. That is, the actual luminance of the CCFL is detected by the photo sensor and compared with a desired luminance output using two integrators, the difference of which is used to automatically control the supplied voltage. Although this method can efficiently reduce the warm-up time, it is achieved by controlling the input voltage. Therefore, the CCFL has to sustain a larger electrical current during the warm-up time. This may easily reduce its lifetime. Moreover, since the input voltage is controlled by the detected luminance, the environmental light or even the document itself will affect the detection of the photo sensor, resulting in insufficient warm-up time or overheating.

Therefore, how to quickly warm up a CCFL and make it stably emit light, without sacrificing its lifetime, is an important topic of the field.

### SUMMARY

Accordingly, the present invention is directed to an inverter and a method for rapid warm-up of luminance loadings to solve the problem in the prior art that the luminance loading cannot quickly reach the temperature required for stable luminance.

The invention is to provide an inverter and a method for rapid warm-up of luminance loadings to auto-adjust the supply power applied to the luminance loadings based on temperature of the luminance loadings. In other words, since changes of the temperature of the luminance loadings follow the voltage which is applied to the luminance loadings, the temperature is detected by a senor and then the corresponding voltages are supplied to the luminance loadings based on the detected temperature.

The disclosed rapid warm-up inverter includes a voltage source, a voltage regulator, a sensor, and a converter. When the luminance loading is turned on, the sensor immediately detects the environmental temperature to determine the energy required for making the luminance loading stably emit light, and a feedback signal is sent to the voltage regulator to provide the luminance loading with a large energy. Moreover, during the warm-up process, the sensor automatically detects the environmental temperature raised by the luminance loading, thereby determining the energy required in addition for the luminance loading to reach the stable state. Also, a feedback signal is sent to the voltage regulator for it to trigger a transformer to provide the needed energy. Consequently, the luminance loading using the invention can be immediately warmed up to stably emit light.

The converter includes an oscillation circuit and a transformer. The oscillator is composed of two transistors, and converts the signal sent out by the voltage regulator, into a corresponding oscillation frequency, which is further converted by the transformer into an AC voltage as a driving output in order to drive the luminance loading.

The invention also provides a method for rapid warm-up of luminance loadings. The inverter is used to start at least one luminance loading. The method includes the following steps. When the inverter receives a starting signal, it detects the temperature of the luminance loading. A voltage is outputted, according to the detected temperature, to the luminance loading for its temperature to rise. The output voltage is at an appropriate level to enable the luminance loading to stably emit light. During the warm-up period, detecting the rising temperature of the luminance loading continues and the output voltage level is automatically adjusted according to the detected temperature. Since an appropriate voltage is supplied to the luminance loading according to the detected temperature, the luminance loading is able to quickly reach the temperature for stable radiation. Aside from the purpose of rapidly warming up the luminance loading, the invention can also solve the problem that the luminance loading may become unstable after the inverter is instantaneously shut down and turned on again because the rapid temperature drop.

### BRIEF DESCRIPTION OF THE DRAWINGS

The invention will become more fully understood from the detailed description given hereinbelow illustration only, and thus are not limitative of the present invention, and wherein:

FIG. 1 shows the relationship between the temperature and surface brightness of the CCFL;

FIG. 2 is an effective circuit diagram of an immediate warm-up inverter according to an embodiment of the invention;

FIG. 3 is the time-brightness relation diagram for the disclosed inverter to restart after an instantaneous breakdown; and

FIG. 4 is the time-brightness relation diagram for the inverter according to an embodiment of the invention to restart after an instantaneous breakdown.

### DETAILED DESCRIPTION OF THE INVENTION

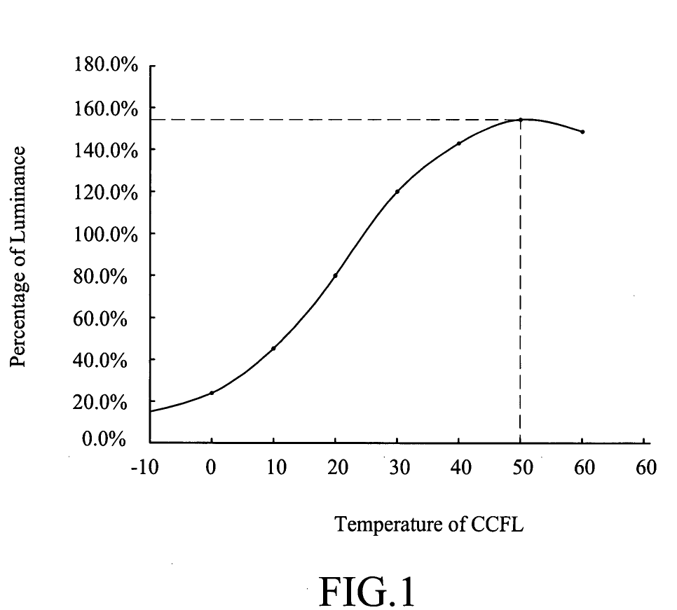

In fact, the CCFL is an element, which is very sensitive to heat. When a large energy is supplied to the CCFL, its temperature and surface brightness will increase simultaneously, both presenting uprising curves. For example, as shown in FIG. 1, when the temperature of the lamp is below 50° C., the relation between its temperature and surface brightness is an uprising curve. Beyond 50° C., the curve bends down. In other words, at 50° C., the CCFL will reach its stable luminance. Therefore, from the relation between its temperature and surface brightness, we choose an appropriate sensor which matches with the converter in the inverter. The sensor, such as a thermistor, automatically changes its resistance according to the detection of the environmental temperature which is raising, thereby feedbacks to control the power supplied to the luminance loadings. Therefore, the luminance loadings can be immediately warmed up. Even if it is instantaneously shut down and restarted, the luminance loadings can be immediately warmed to stably emit light. In fact, lamps of different lengths and diameters have different relations between the temperature and the surface temperature. That is, the temperature for stable luminance may be different. Even if one only increases the number of lamps being used, the temperature for stable luminance will be different, too. Therefore, one can experiment with different cases to find a thermistor having an appropriate standard resistance. Moreover, the so-called standard resistance refers to the resistance of the thermistor at a temperature below 25° C.

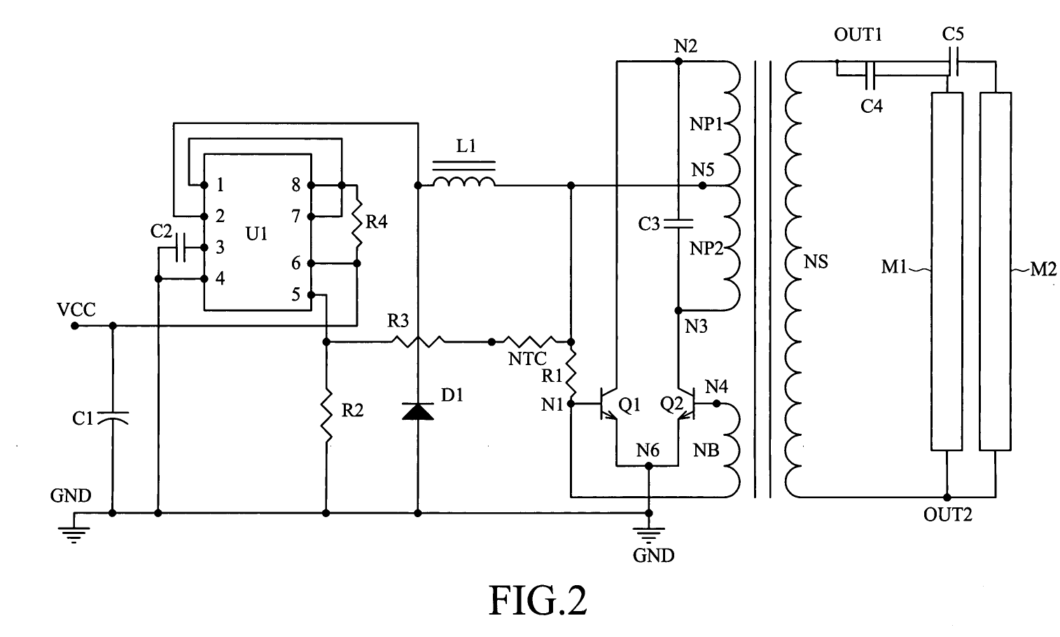

The disclosed inverter for rapid warm-up of luminance loadings includes a voltage source, a sensor, a voltage regulator, and a converter. As shown in FIG. 2, the voltage source is used to provide an input voltage. In addition, a filtering capacitor, a shock protection circuit, or a switch for controlling the on and off of the inverter can be designed to the voltage source VCC. The sensor, e.g. a thermistor, is an impedance device, which detects the environmental temperature and changes its resistance according to the environmental temperature. An appropriate voltage regulator is selected according to the sensor. The voltage regulator can be a microprocessor, such as the 8-pin IC of MC34063 or MC3593. The temperature detected by the sensor is then used to adjust the input voltage (i.e. raising or lowering the input voltage) for outputting to the converter. Finally, the converter is a transistor converter and a push-pull converter, which includes an oscillation circuit and a transformer. The oscillation circuit consists of two transistors and provides an oscillation frequency according to the input voltage regulated by the voltage regulator. The transformer then outputs an AC voltage according to the oscillation frequency, to drive the luminance loadings.

As shown in FIG. 2, the inverter has a voltage source VCC, a ground line GND, and output terminals OUT1, OUT2.

A filter, the first capacitor C1 here, is coupled between the voltage source VCC and the ground line GND. The first capacitor C1 is mainly used to eliminate ripples. It is rapidly charged by the voltage source VCC and slowly discharges before the next charging. The slow discharge speed hinders the voltage of the first capacitor C1 from dropping, resulting in the fact that the input voltage has a stable level. That is, the first capacitor C1 can stop the input voltage from changing after being charged by the voltage source VCC. The input voltage thus becomes smoother.

The voltage regulator here is a microprocessor U1, which can be an IC with eight pins, as shown in the drawing. The voltage source VCC is connected to the sixth pin 6 of the microprocessor U1. The first pin 1, the seventh pin 7, and the eighth pin 8 of the microprocessor U1 are connected. A diode D1 is coupled between the second pin 2 and the ground line GND. A second capacitor C2 is coupled between the third pin 3 and the ground line GND. The first pin 4 is directed connected to the ground line GND. A second resistor R2 is coupled between the fifth pin 5 and the ground line GND. Finally, the sixth pin 6 is connected, in series, to a fourth resistor R4 before being connected to the eighth pin 8. The input voltage from the voltage source VCC enters the microprocessor U1 via the sixth pin 6. The fifth pin 5 of the microprocessor U1 receives a feedback signal, which corresponds to the energy that is provided to the luminance loadings. The microprocessor U1 compares the received feedback signal with a reference signal, which is already determined by the microprocessor and which varies for different types of processors. And the microprocessor U1 uses the comparison result to regulate the input voltage. The adjusted voltage is outputted via the second pin 2 of the microprocessor U1. In brief, when the input voltage is higher than that which is supplied to the luminance loadings to reach its stable luminance thereof, the microprocessor U1 adjusts the input voltage in order to output the lowering input voltage. The diode D1 coupled to the second pin 2 of the microprocessor U1 becomes a voltage restricting circuit due to its one-way conduction property for protecting the circuit.

Moreover, the second pint 2 of the microprocessor 1 is connected to one end of a filter. The other end of the filter is connected to a node N5. Here the filter is an inductor LI, which is iron-core-type inductor. Generally speaking, an input current accompanies the input voltage. The inductor LI can prevent the current from changing, making the input current smooth and achieving the filtering effect.

The sensor in this embodiment is a thermistor NTC with a negative temperature coefficient. One end of the sensor is coupled to the fifth pin 5 of the microprocessor U1 via the third resistor R3. The other end is coupled to the node N5 and to the ground line GND via the first resistor R1. A node N1 is between the first resistor R1 and the ground line GND. The thermistor detects the environmental temperature, i.e. the temperature of the luminance loadings, and adjusts its resistance as the temperature goes up. A feedback signal is provided by the thermistor to the microprocessor U1. Therefore, a thermistor with an appropriate standard resistance is selected according to the temperature for the luminance loadings to stably emit light. An appropriate type of microprocessor is also selected according to the thermistor. Otherwise, it cannot achieve the desired immediate warm-up effect.

An oscillation circuit is coupled among the nodes N1, N2, N3, and N4, and consists of a first transistor Q1, a second transistor Q2, and a third capacitor C3. A transformer is coupled among the nodes N1˜N5 and the output terminals OUT1, OUT2. The transformer consists of a preliminary coil, a secondary coil NS, and a feedback coil NB. The preliminary coil is one with outputs in the middle, labeled by NP1 and NP2. The base of the first transistor Q1 is connected via the node N1 to one end of the feedback coil NB. The other end of the feedback coil NB is connected to the base of the second transistor Q2. The common input node N5 of the preliminary coil NP1, NP2 is connected via the inductor LI to the second pin of the microprocessor U1. The power is supplied through the node N5. The emitters of the first and second transistors Q1, Q2 are both connected to the ground line GND. The collector of the first transistor Q1 is connected to the other end of the preliminary coil NP1 via the node N2. The collector of the second transistor Q2 is connected to the other end of the preliminary coil NP2 via the node N3. The preliminary coil NP1, NP2, and the third capacitor C3 are connected in parallel between the nodes N2 and N3.

The fourth capacitor C4 is connected to a first luminance loading M1. The fifth capacitor C5 is connected to a second luminance loading M2. The first luminance loading M1 and the second luminance loading M2 are coupled in parallel between the output terminals OUT1 and OUT2 of the secondary coil NS. Moreover, the first luminance loading M1 and the second luminance loading M2 are connected in series with the fourth capacitor C4 and the fifth capacitor C5, respectively, in order to stabilize the output voltage of the two luminance loadings M1, M2.

When the regulated voltage is outputted via the second pin 2 of the microprocessor U1, the accompanied input current flows through the two transistors Q1, Q2. The two transistors may be slightly different in their properties. Therefore, one of them conveys a larger current. If the first transistor Q1 has a larger current, then the input current flows from the node N2 via the preliminary coil NP1 to the node N5. Thus, the uprising current in the circuit increases the magnetic field, thus, an induced voltage is generated between the preliminary coil NP2 and the feedback coil NB. The polarities of the voltages at the end of the preliminary coil NP2 in the vicinity of the node N3 and the end of the feedback coil NB in the vicinity of the node N4 are negative. The polarities of the other ends of the two coils are positive. Since the base of the second transistor Q2 approaches a negative potential, the second transistor Q2 will shut down. On the other hand, the base of the first transistor Q1 approaches a positive potential, thus the firs transistor Q1 will saturate. In the end, the first transistor Q1 is in the ON state while the second transistor Q2 is in the OFF state.

As the induced electric potential on the feedback coil NB decreases, the forward bias of the first transistor Q1 decreases, resulting in decreasing collector current on the first transistor Q1. Therefore, the magnetic field of the preliminary coil NP1 is released. A voltage with the opposite polarity is then induced on the secondary coil NS. Since the voltage on the base of the first transistor Q1 is positive, the first transistor Q1 shuts down. At the same time, the voltage on the base of the second transistor Q2 is positive, the second transistor Q2 is conducting and saturates. Therefore, the second transistor is in the ON state, and the second transistor Q2 is in the OFF state. Such actions continue repeatedly. Thus, the secondary coil NS has two opposite pulses. Through the coil ratio of the transformer, the output voltage is increased. From the above-mentioned circuit operations, it can be known that the two transistors Q1, Q2 become conductive alternatively and approach saturation. Thus, the secondary coil NS outputs an AC voltage. Since the two transistors Q1, Q2 operate at the minimum power loss states, the efficiency of the circuit is very good.

In other words, when the regulated voltage is inputted to the base of the first transistor Q1, the voltage difference between the node N1 and the ground line GND changes as the input voltage. Therefore, the first transistor Q1 alternates between its ON and OFF states according to the pulse variation of the input voltage. Since the first transistor Q1 and the second transistor Q2 are disposed in a symmetric way, and the preliminary coil NP1 and the preliminary coil NP2 are disposed in a symmetric way, the symmetry is broken when the input voltage is a high voltage level. As a result, the voltages on the nodes N2 and N3 are different, which means that the input voltage is converted by the preliminary coils NP1, NP2 and the secondary coil NS, into an AC output. When the input voltage is a low level (usually 0), the work voltage is zero because of the symmetry structure. In this case, the output voltage is zero. That is, when the voltage is supplied to the node N1, the two transistors Q1, Q2 become a switch, so that the input voltage is converted into the work voltage passing through the switch. In the end, the desired output voltage is obtained after the conversion of the transformer.

Hereinafter, we will explain the following the operation principle of the disclosed inverter. Before installing the microprocessor and the thermistor, when the power is supplied from the input terminal, the oscillation circuit outputs the oscillation frequency in response to the power, and the oscillation frequency is converted by the transformer into an appropriate output voltage to start the first and second luminance loadings M1, M2, wherein the oscillation circuit is composed of the first and second transistors Q1, Q2, and the transformer is composed of the coils NP1, NP2, NB, NS, In this circuit structure, the luminance loadings M1, M2 require a longer time to stably emit light.

After installing the microprocessor U1 and a negative-temperature-coefficient thermistor NTC, a large input voltage is supplied to the luminance loadings when they are started. The input voltage has a level that can immediately warm up the luminance loadings. During the warm-up process, the microprocessor U1 lowers the input voltage as the thermistor NTC detects the temperature. In other words, as the temperature rises, the thermistor NTC detects the rise in temperature and lowers its resistance. A corresponding feedback signal of the reduced resistance is sent to the microprocessor U1. The microprocessor U1 lowers the input voltage according to the feedback signal and outputs a regulated input voltage. And the transformer provides the luminance loadings with an AC voltage according to the reduced input voltage Therefore, the above operation enables the luminance loadings M1, M2 to immediately reach stable luminance. Moreover, when the circuit is instantaneously shut down, the first and second luminance loadings M1, M2 shut down and quickly reduce their temperatures due to their properties. On the contrary, when the inverter restarts the luminance loadings, they have to return to the previous stable state as soon as possible. Therefore, no matter how dramatic the temperature drop of the luminance loadings is, the invention still uses the thermistor NTC to detect the temperature, and the microprocessor U1 then provides an appropriately large input voltage according to the temperature detected by the thermistor NTC, enabling the first and second luminance loadings M1, M2 to reach stable luminance.

We use the CCFL as the luminance loading in the disclosed inverter and the method thereof to verify that the invention indeed can achieve the effects of immediate warm-up and quick continual.

Using the disclosed inverter, the time needed for stabilization can be greatly reduced.

Using a negative-temperature-coefficient thermistor with a standard resistance of 10K and a MC34063 IC along with a negative-temperature-coefficient thermistor with a standard resistance of 47K along with the MC3593 IC, the scanning device can be quickly started without wasting time to wait the light source to stabilize.

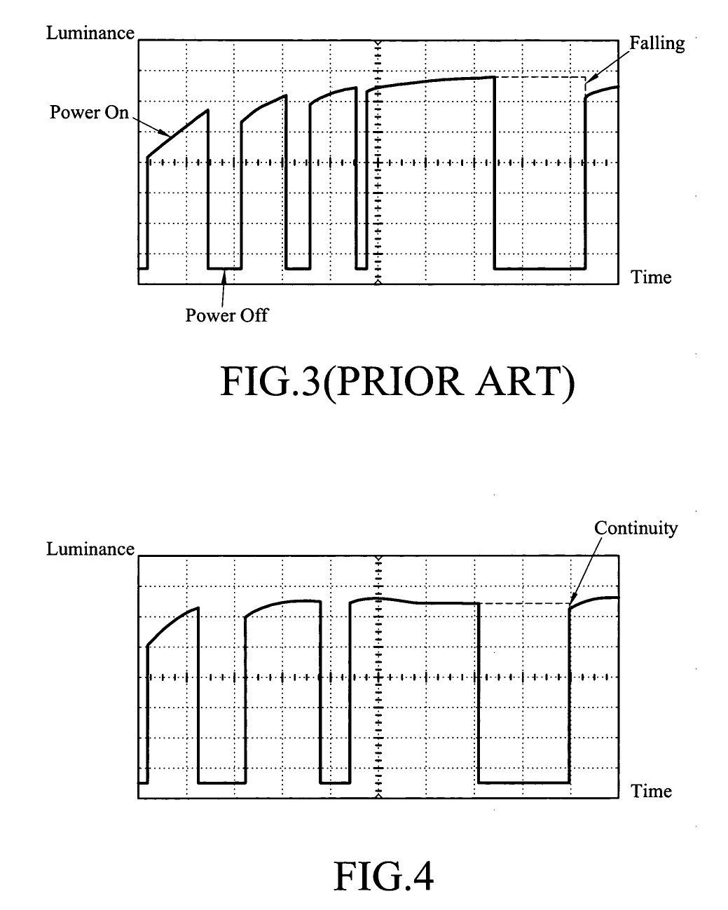

In the performance of continuality, we refer to FIGS. 3 and 4. FIG. 3 is the time-brightness relation diagram for the disclosed inverter to restart after an instantaneous breakdown. FIG. 4 is the time-brightness relation diagram for the inverter according to an embodiment of the invention to restart after an instantaneous breakdown. By comparing FIGS. 3 and 4, we find that when there is a sudden breakdown, the brightness quickly drops. When it is restarted, the continuality of the disclosed inverter is better than the prior art.

Certain variations would be apparent to those skilled in the art, which variations are considered within the spirit and scope of the claimed invention.

What is claimed is:

1. An inverter for rapid warm-up of luminance loadings to start at least one luminance loading, the inverter comprising:
a voltage source, which provides an input voltage;
a sensor, which detects temperature of the luminance loading and which outputs a feedback signal corresponding to the temperature;
a voltage regulator which is connected to the sensor and which regulates the input voltage from the voltage source according to the feedback signal; and
a converter, which converts the regulated input voltage into an AC voltage and which outputs the AC voltage to drive the luminance loading.

2. The inverter of claim 1, wherein the sensor is a thermistor.

3. The inverter of claim 2, wherein the thermistor is one of a positive temperature coefficient (PTC) thermistor and a negative temperature coefficient (NTC) thermistor.

4. The inverter of claim 2, wherein the standard resistance of the thermistor is determined by the temperature at which the luminance loading emit light stably.

5. The inverter of claim 1, wherein the luminance loading is a cold cathode fluorescent lamp (CCFL).

6. The inverter of claim 1, wherein a capacitor for filtering is selectively set between the voltage source and the sensor.

7. The inverter of claim 1, wherein the voltage regulator decreases the input voltage when the input voltage is larger than the voltage required by the luminance loading.

8. The inverter of claim 1, wherein the voltage regulator increases the input voltage when the input voltage is smaller than the voltage required by the luminance loading.

9. The inverter of claim 1, wherein the voltage regulator is a microprocessor.

10. The inverter of claim 9, wherein the microprocessor is an MC34063 IC.

11. The inverter of claim 9, wherein the microprocessor is an MC3593 IC.

12. The inverter of claim 9, wherein the microprocessor is an 8-pin IC with the voltage regulating function.

13. The inverter of claim 9, wherein the first pin, the seventh pin, and the eighth pin of the microprocessor are coupled together and to the sixth pin via a fourth resistor, the second pin is coupled to an inductor for filtering, the third pin is coupled to the fourth pin and the ground line via a capacitor, the fifth pin is coupled to the sensor via a third resistor, and the sixth pin is coupled to the voltage source.

14. The inverter of claim 13, wherein the inductor is an iron core inductor.

15. The inverter of claim 1, wherein the converter is a push-pull converter.

16. The inverter of claim 1, wherein the converter includes:
an oscillation circuit for outputting an oscillation frequency according to the regulated input voltage; and
a transformer coupled in parallel with the oscillation circuit for outputting the AC voltage according to the oscillation frequency to drive the luminance loading.

17. The inverter of claim 16, wherein the oscillation circuit includes a first transistor and a second transistor, and the first and the second transistors couple with each other in series.

18. The inverter of claim 17, wherein the first and the second transistors are both of the NPN form.

19. The inverter of claim 17, wherein the oscillation circuit has a capacitor coupled in parallel with the first transistor and the second transistor.

20. The inverter of claim 17, wherein the output terminal of the transformer is coupled with a capacitor in series.

21. A method for rapid warm-up of luminance loadings to start at least one luminance loading, the method comprising the steps of:
detecting temperature of the luminance loading when a starting signal is received;
outputting a voltage to the luminance loading according to the detected temperature to rise the temperature of the luminance loading, wherein the voltage is at a level that enables the luminance loading to emit light stably; and
detecting the uprising temperature of the luminance loading during the warm-up of luminance loading and automatically adjusting the level of the voltage according to the detected temperature.

22. The method of claim 21, wherein the luminance loading is a CCFL.

23. The method of claim 21, wherein a thermistor is used to detect the temperature of the luminance loading and the standard resistance of the thermistor is determined by the temperature at which the luminance loading emits light stably.
